(19) United States
(12) Patent Application Publication
(10) Pub. No.: US 2011/0311228 A1
(43) Pub. Date: Dec. 22, 2011

(54) Communication Apparatus for Communication in a Medium and a Manufacturing Method

(75) Inventors: Mika Leivo, Helsinki (FI); Juha-Matti Liukkonen, Helsinki (FI)

(73) Assignee: LIVELOCK OY, Helsinki (FI)

(21) Appl. No.: 13/139,037

(22) PCT Filed: Dec. 10, 2008
(86) PCT No.: PCT/EP2008/067212

§ 371 Date: Sep. 6, 2011

(51) Int. Cl. H04B 10/00; H04J 14/00

(52) U.S. Cl. 398/78; 398/116

(57) ABSTRACT

Invention shows an electro-optical key arrangement comprising for a key of the key arrangement comprises: a transmitter (LED1) arranged (G1,G2,G3) to transmit photon radiation at a wave-length range comprising at least one wave length, into a wave guide forming an optical path, a receiver (LED2) arranged to receive, said photon radiation on said at least one wave length, at least partly from said optical path, and to convert said photon radiation into an electric form to be used for an electric signal, and a detector circuit (D1,D2,D3) arranged to detect changes in said photon radiation received for forming a specific electric signal as a key (Q1,Q2,Q3) specific signal. In said arrangement said transmitter (LED1) and said receiver (LED2) are arranged into the same in-cast molded structure body (KB), that further comprises said optical path, arranged into a geometry (LED1, LED2,F) so that touching (F) of the optical path there between said transmitter (LED1) and said receiver (LED2) as an initiation causes a key specific signal as a response in the detector circuit (D1,D2,D3).

### FIELD OF THE INVENTION

The invention relates to communication technology in a very general level, but more specifically to a key arrangement as defined in the preamble of an independent claim thereon.

The invention also relates to use of the keyboard as defined in the preamble of an independent claim thereon.

The invention also relates to the communicator as defined in the preamble of an independent claim thereon.

The invention also relates to the communication system as defined in the preamble of an independent claim thereon.

The invention also relates to use of the key arrangement in communication as defined in the preamble of an independent claim thereon, comprising the use in a medium.

The invention also relates to manufacturing method of the key arrangement.

### BACKGROUND

Although the communications devices has been strongly developing at the priority date of the current patent document, the hand held communication devices have with almost no exception a button pad or a key board as the writing with a key board still appears to be a common way of communicating between the individual users of various apparatus, i.e. as using the Internet, and/or mobile networks. The key boards, as various collections of buttons in the devices arranged to control the devices, especially portable devices, are called in the following, may comprise different numbers of buttons or keys. Depending on the purpose of the device, the device may comprise a full type-writing key board familiar from the computer key boards and similar ones, or key board in which the keys have more than one meaning until in the use a special action is made to point out the desired character from a single key. An example is given as referring to certain mobile phones and their key-boards. The action may be pressing sift button or another key, as many as such there may be for giving a different appearance for the character pressed at the key simultaneously with the sift, for example. In small key boards the number of pressing a key several times may lead to the desired character to appear on the screen. Also predictive algorithms can be used to pace the writing.

However, the key boards of known techniques are often mechanical key boards designed so that the moving mechanical parts are almost impossible to avoid in such key boards. Also some optical key boards are known. In such known key boards there can be a light beam generated pattern of key board, and the respective finger movements and the finger places on the patterns are detected and/or recorded and the positions interpreted as key locations. However, these key boards need a screen on which the key board pattern is shown.

Known key boards are electromechanical although some may comprise also some optics. Such structure may cause problems to the key board operation in conditions where liquid phase (water or other liquid) is present, or is expected to be. Conventional key board operation may be very difficult if not totally impossible in such conditions. The mechanical key boards cannot be washed, which limits their utilizability in such conditions where there can be biologically, chemically and/or radioactively hazardous materials present, or an intake probability of such materials into the key board is considerably high. Also, in vacuum conditions as in the space, the conventional key boards may be clumsy and hard to use in a rational manner.

### OBJECTIVES OF THE INVENTION

According to a first aspect of the invention an object of the invention is to provide a key arrangement that gives the benefits of conventional keys to the keys of the key arrangement so as the keys were keys of a conventional key board to be used in operation in a versatile way, but also in various media easily and reliably.

According to a second aspect of the invention, an object of the invention is to provide such a key arrangement that adds to the first aspect so that the keys of the key arrangement are also at least vapor tight and the keys of the key arrangement tolerate at least the same conditions as the intended users of the key arrangement.

According to a third aspect of the invention an object of the invention is to provide such a key arrangement that adds to the first and/or second aspect for a key board that utilizes the key arrangement.

According to a fourth aspect of the invention an object of the invention is to provide a communication device and/or a system that utilizes such a key arrangement that adds to the first, second and/or third aspect.

According to a fifth aspect of the invention an object of the invention is to provide a manufacturing method for devices in accordance of the first, second, third and/or fourth aspects.

An electro-optical key arrangement according to the invention is characterized by the definitions of an independent claim directed to the electro-optical key arrangement.

Preferred embodiments are shown for the electro-optical key arrangement as defined in the dependent claims 2-10 directed thereon.

A key board according to the invention is characterized by the definitions of an independent claim directed to the key board.

A communicator according to the invention is characterized by the definitions of an independent claim directed to the communicator.

Preferred embodiments are shown for the communicator as defined in the dependent claims 12-17 directed thereon.

A use according to the invention is characterized by the definitions of an independent claim directed to the use.

An example on preferred embodiment is shown for the use as defined in the dependent claim 19 directed thereon.

An electro-optical key arrangement, comprising at least a key in the key arrangement that key comprises
a transmitter for a key arranged to transmit photon radiation at a wave-length range comprising at least one wave length, into a wave guide forming an optical path,
a receiver for a key arranged to receive, said photon radiation on said at least one wave length, at least partly from said optical path, and to convert said photon radiation into an electric form to be used for an electric signal,
a detector circuit arranged to detect changes in said photon radiation received for forming a specific electric signal as a key specific signal,

wherein
said transmitter and said receiver are arranged into the same in-cast molded structure body, that further comprises said optical path, arranged into a geometry so that touching of a part of the optical path there between said transmitter and said receiver as an initiation causes a key specific signal as a response in the detector circuit.
   According to an embodiment of the invention the electro-optical key arrangement according to an embodiment comprises in said electro-optical key an LED as said transmitter and/or a LED as said receiver.

According to an embodiment of the invention the electro-optical key arrangement according to an embodiment comprises in said optical path a wave-guide part for guiding photon radiation between said transmitter and receiver.

According to an embodiment of the invention the electro-optical key arrangement according to an embodiment comprises in the detector circuit at least one said receiver.

According to an embodiment of the invention the electro-optical key arrangement according to an embodiment comprises for each key as a key specific component at least one of the following: a receiver, a transmitter, and a detector circuit.

According to an embodiment of the invention the electro-optical key arrangement according to an embodiment comprises in a plurality of keys at least a first key and a second key so that for said first key the key specific component is different than for said second key.

According to an embodiment of the invention the electro-optical key arrangement according to an embodiment comprises the transmission of the photon radiation transmitter as key-specifically coded by a coder to distinguish a first key from another key in a time-divisional space of coding of the keys.

According to an embodiment of the invention the electro-optical key arrangement according to an embodiment, at least a first key and a second key comprise respectively a first optical path and a second optical path from a common transmitter.

According to an embodiment of the invention the electro-optical key arrangement according to an embodiment, at least a first key and a second key comprise respectively a first optical path and a second optical path leading to a common receiver.

A key board according to an embodiment of the invention comprises keys in an assembly of key board keys comprising therein at least one electro-optical key arrangement according to an embodiment of the invention.

A communicator according to an embodiment of the invention comprises a key board according to an embodiment of the invention.

According to an embodiment of the invention the communicator according to an embodiment comprises a transducer arranged to operate as a transmitter and/or receiver arranged to, respectively, transmit and/or receive acoustic pulses as digital signals.

According to an embodiment of the invention the communicator according to an embodiment comprises a repeater arranged to repeat a received acoustic signal. In such embodiment the signal that is listened may be amplified, the frequency and/or coding may altered to better fit to the system as arranged.

According to an embodiment of the invention the communicator according to an embodiment comprises a transducer arranged to transmit and/or receive an acoustic signal into a medium in a time division multiple access (TDMA) scheme.

According to an embodiment of the invention the communicator according to an embodiment comprises a transducer arranged to transmit and/or receive an acoustic signal into a medium in a code division multiple access (CDMA) scheme.

According to an embodiment of the invention the communicator according to an embodiment of the invention is arranged to communicate via a network access protocol.

According to an embodiment of the invention the communicator is arranged to communicate via an encrypted code.

According to an embodiment of the invention the communicator according to an embodiment comprises a spreading means arranged to spread and/or de-spread a signal in an embodiment of the invention for encoding/decoding a signal to be communicated between two devices.

According to an embodiment of the invention the communicator according to an embodiment comprises electronics for an acoustic modem adapted to operate on an acoustic carrier in the medium.

According to an embodiment of the invention the communicator according to an embodiment comprises at least one of the following: means for error correction, means for encryption, means for package collision handling, means for providing a message with an overhead of the information transference protocol.

According to an embodiment of the invention the use according to an embodiment comprises use of a key board according to an embodiment, in communication in a medium.

According to an embodiment of the invention the use according to an embodiment comprises as said medium at least one of the following: water, air, other gas than air, a partial vacuum and a multi-phase medium.

A system according to an embodiment of the invention comprises at least one communicator according to an embodiment of the invention arranged to communicate with another communicator for communication in a medium.

A manufacturing method according to an embodiment of the invention comprises:

setting components of a key arrangement into an assembly for the key arrangement into a mold for casting plastic forming substances in the mold,

casting the plastic forming substances into the mold or optionally dipping repeatedly the assembly to plastic forming composition, for forming in-cast structure for the key arrangement.

hardening the plastic, so that the key arrangement is sealed into the plastics.

### LIST OF FIGURES

In the following the invention will be described in more detail by referring to the FIGS. 1-6, which show examples on embodiments of the invention. The shown aspect ratios, dimensions and further geometrical properties are shown in illustrative manner. Thus the shown dimensions are not necessarily in scale. The figures and/or examples are not intended to restrict the scope of any embodiments merely to the shown. So, the figures FIG. 1-FIG. 6 to be attached to disclosure of the description illustrate examples on the embodiments of the invention as follows:

FIG. 1 illustrate examples to implement embodiments of the invention,

FIG. 2 illustrate details on embodiments of examples on embodiments of the invention,

FIG. 3 illustrates block diagram on an embodiment of the invention,

FIG. 4 illustrate examples of use of embodiments of the invention,

FIG. 5 illustrates utilization of the embodiment of the invention,

FIG. 6 illustrates manufacturing method of a device according to an embodiment of the invention, and

FIG. 7 illustrates examples on embodiments of the invention and operative aspects thereon.

Further examples of embodiments of the invention are shown in the description in the examples and in the dependent claims. Various embodiments of the invention are combinable in suitable part. The term comprise has been used as an open expression, as such or in its deflected forms. Same reference numerals or labels are used in different FIGS, if not otherwise indicated. The parts so indicated are not necessarily exactly the same, but a skilled man in the art can understand the potential differences according to the context in the figures and/or the related part of the description.

### DETAILED DESCRIPTION OF EMBODIMENTS OF THE INVENTION

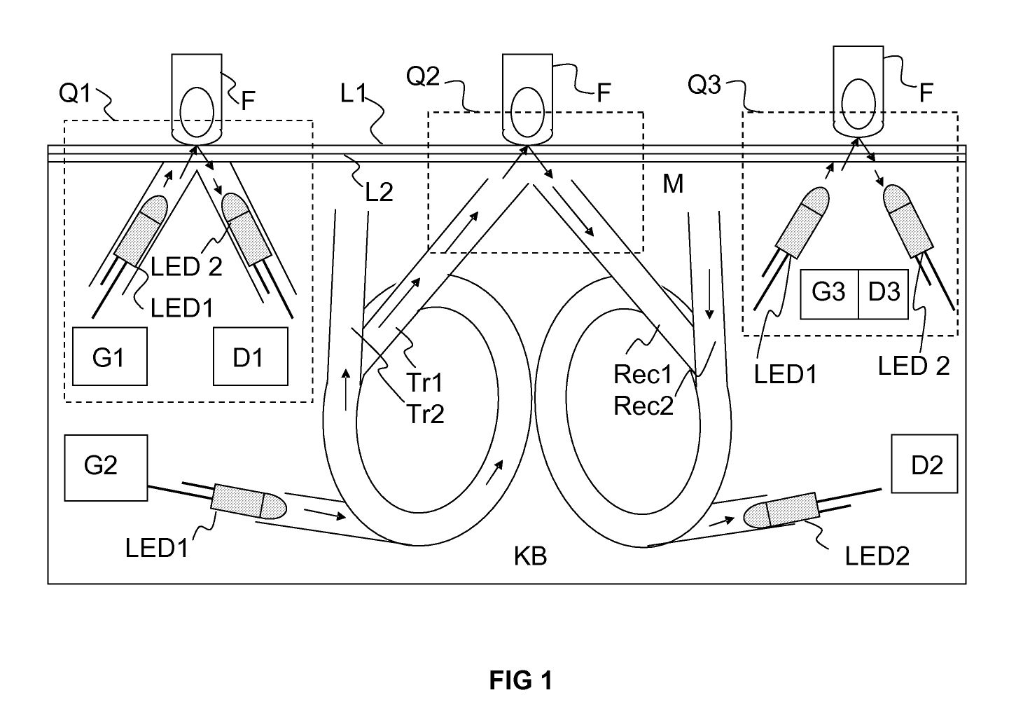

FIG. 1 illustrates examples of key arrangements according to embodiments of the invention. In each shown example the key arrangement is electro-optical, as the keys that are indicated by the Q1, Q2 and Q3 for the key area, use light to be coupled from a radiation source that is indicated by the LED1. The LED2 in the FIG. 1 illustrate receiver that is arranged to receive at least partly the radiation transmitted from the LED1 via the keying member F.

The G1 illustrate the generator that provides the electricity in suitable wave form for lighting the LED1. At its simplest, the G1 merely provides a DC-voltage and current for the LED1 to enlighten and shine following the voltage over the LED1, so with DC continuously according to that embodiment in question. However, according to another embodiment the G1 can be controlled by a controller or a keying system, in a control of a micro processor to enable utilization of different wave forms with pulse characteristics differing from the mere DC-voltage and/or current, according to the very embodiment. According to an embodiment the G1 can generate pulses according to which the LED1 enlightens and shine during the pulse duration. According to an embodiment the G1 is controlled by microprocessor directly, but according to another embodiment via a keying means. The pulse can be a digital pulse, but can comprise a different shape in time space as pulse characteristic, however such characteristics that it is detectable for recognition to be distinguished from other pulses for other keys in the same system. Between two successive such pulses that allow the LED1 shine in a key, the LED1 keeps darker, if not totally switch off according to the pulse duration. According to an embodiment, the G1 is so controlled that for each key of the key board as embodied according to the embodiment of the invention there is an ensemble of pulses and their pitches that comprise for a pulse a pulse duration and/or the pitch duration to the next pulse in the ensemble of pulses so that the key is recognizable according to the pulse pattern of the ensemble of pulses. According to an embodiment the ensemble of the pulses is a key specific sequence of wave forms, but in digital embodiment the sequence forms a key specific word, whose length in bits depends on the number of the keys in the keyboard that are implemented according to an embodiment of the invention.

Such coding of the keys is beneficial to reduce interference, but also to reduce current consumption and thus increase the power source durability in as hand-held embodied devices utilizing the key arrangement, if compared to merely having continuous DC-current lighting of the LED1.

According to a further economical ensemble of embodiments of the invention are demonstrated by the key Q2 and the related key area. These embodiments comprise a common transmitter and/or a common receiver, also denoted as common transmitter embodiment and common receiver embodiment, respectively.

Such further economical embodiments in respect to the power consumption perspective are illustrated by the key Q2 that is implemented so that there is a LED1 as for the key Q1 in the Q2, but the Q2 key or button geometry is implemented by a different wave-guide as in Q1 for the LED1 to direct the light to the key area to enable the light coupling to the LED2 by the keying member F.

According to an embodiment the wave guide branches to Tr1 and Tr2, so that the light originating to the LED1 can be directed along the branches to several keys or buttons, even to the whole assembly of key board keys implemented according to an embodiment of the invention, so that at least one branch extends to at least one key. For example, the branching can be arranged so that if there were 32 keys according to the key arrangement embodiment of the invention, there were 32 branches needed for covering all the keys with the LED1 transmission.

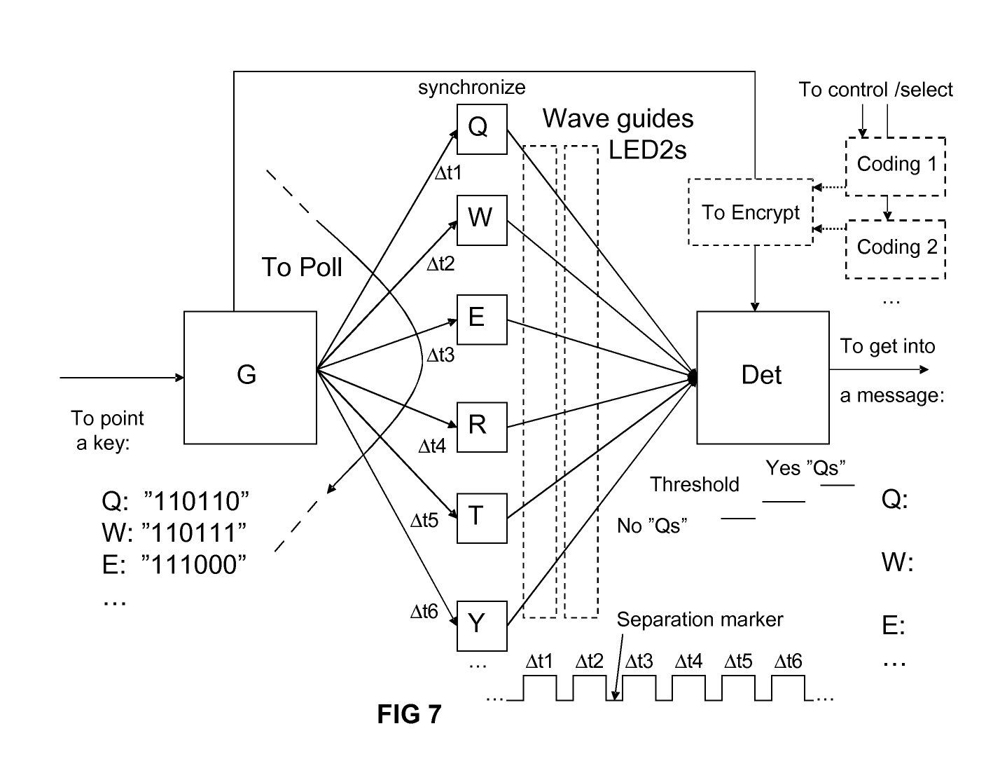

According to an embodiment of the invention, the G2 is arranged to send different pulse ensemble, as a first bit pattern at a first moment for a first key and a second bit pattern at a second moment for a second key for example, etc., in similar manner for each key, so that all the key board keys in the group with the parallel branches are polled in time series during a preset time interval in the LED1's transmission sequence. This embodiment is demonstrated with the Q2-button. FIG. 7 illustrates also the polling in a further detail.

For example, a simple way to point up to 32 keys can be made by less than 5 or 5 bits. In such embodiment, the LED1 can send all the five-bit patterns that are addressed each to a key in the sequence repeatedly. Larger keyboards can be controlled by larger amount of bits, so that by six bits 64 keys etc. Smaller key boards can be addressed with fewer bits so that for 16 keys 4 bits were sufficient, but for 28 keys, for instance, 5 bits were sufficient.

According to an embodiment of the invention the key sequence can be repeated at least once in time scale that is shorter than 20 ms, but more preferably in scale that is shorter than 1 ms. So such polling is giving time to the analyzing electronics for recognizing whole ensembles of bits for each key, even for fast type writers. According to an embodiment the time scale is adjustable even shorter than 6 ms.

According to the above mentioned Q2 related embodiment, each key have its own LED2 to receive the light from the Q2 key area when touched with the keying member and so consequently couple at least some light from the LED1 to LED2. As in that embodiment the LED1 transmits into all the connected branches, the identification of the key location is determined by the LED2 locations and/or the bit patterns. In such embodiment the detection electronics can have a filter that filters out all the other pulses or pulse groups than the one arranged to correspond the Q2 specific key and so pass the filter in such a way that the touch is counted as pressing the very key. According to an embodiment, the signal from the G2 can be directed to each keys' LED2, so that detector electronics in D2 can keep the unnecessary LED2s in sleep mode during a certain bit patterns and awake during the correct bit pattern, thus avoiding the power consumption during a non-relevant transmission of the LED1. In other words, the detection electronics can be so arranged to control so that the correct LED2 is read during the corresponding part in the transmission of the LED1. However, in this kind of embodiment the electronics may be more complicated than in such embodiments in which the bit pattern acceptance is based on the signal threshold level difference from the pre-set threshold level as to indicate to the analyzing electronics a touched key.

According to another embodiment the roles of the LED1 and LED2 are switched/mirrored in a certain way so that in such an embodiment from each key, as exemplified by the Q2 key in FIG. 1, a branch indicated by the Rec1 leads from the key area of the Q2 to the LED2, the LED2 to be used as receiver for the detector-electronics D2. In such embodiment, a common detector LED2—a group of transmitters LED1 embodiments, the G2 is arranged to operate for the certain key with the bit pattern addressed to the key symbol. In such an embodiment, the key board key location of the Q2 can be addressed according to the key specific transmission (LED1) from the key specific location. This can be implemented in several ways. According to an embodiment of the invention G2 is common to the LED1s, but polled for the bit pattern of each key. According to another embodiment of the invention each key has its own LED1 and own G2. The key specific bit pattern can be sent from an own G2 at each key specific location. Another option is to use a G2 to send the signal to each LED1s their bit pattern pulses by utilizing the sleep mode techniques, or to filter out the unnecessary bit patterns before they arrive to the particular LED1 at the key area of the Q2.

Each of the Q2-dedicated LED1s are arranged to send their key specific bit pattern at their own turn. According to a variant of an embodiment, only one ensemble of keys comprising at least one key is listened at once with the LED1 transmission by the LED2 that is arranged to receive all the optical signals from the key board keys.

If all the LED1s were arranged to transmit simultaneously, as in one embodiment ensemble, it could consume more power than utilization of the sleep-mode related transmission LED1s within their own turn, but the topology of the circuitry could be simpler, and thus the manufacturing cost may be lower. In such embodiment all the LED1s in the keys in the assembly can transmit simultaneously. The bit pattern corresponding the correct key is detected in the analyzing electronics by threshold detection for the corresponding bit pattern. In threshold detection according to an embodiment of the invention a threshold is used to determine which bit pattern a key were pressed. In a reflective, positive, mode of detection the pulses extending further away from the zero level than the threshold are accepted for interpretation of pulses in the analyzing electronics for an indication of pressed key, and in order of arrival to indicate the order of the keys pressed, in provision that there are no such delays that would alter the order.

According to an embodiment, the transmission and receiving is made synchronously so that G2 is controllably commanded to poll a LED1 for sending the bit patterns, to be sent each in time, in the key sequence, or, to poll combinations of G2 and LED1s, (the G2 as arranged to latch the LED1 to shine in such embodiment). In synchronous timing, to each of the D2s, they are told by a control signal, a pulse train for example, that now there are “Q”s, for example, to be expected to be detected during the time interval reserved in a key sequence for the key. In such embodiment in which there are many LED2s, each D2 knows that only signals to correspond the Q are latched through to the D2. The filtration or latching can be implemented in several ways, for example by arranging a latch between the D2 and the letter corresponding LED2 so that the latch passes through only certain bit pattern to the D2 for threshold analysis, and according a further embodiment only at a certain time corresponding the moment reserved for the certain key in the key sequence in synchronous moment of LED1 transmission. D2 or the analyzing electronics in suitable part decides was the LED2 received signal level different from the threshold value in an acceptable tolerance for indication for the key (Q for example) to be considered as touched and consequently to be sentenced to the software to be used for the communication, for a message to be written. The controlling can be embodied in many ways, at least by using at least partly utilizable software for the timing.

However, when the turn for the sending of LED1s are arranged to happen in series, and LED1s are arranged to send one by one in a serial way, the power consumption may be lower than in embodiments in which there were more LED1s lighting all at the same time. In such an embodiment the signal from the G2 of each sending LED1 can be directed to D2 so it knows actually what optical key it is about to listen according to the LED1 location at the key area of the key.

According to an embodiment of the invention there can be single LED1 and single LED2 as used the transmitter and the detector for a group of the key board keys, if not all of the keys in the key board were in the same group, the embodiment denoted also with the abbreviation DWGE as Double Wave Guide Embodiment, or as Common Transmitter Common Receiver Embodiment (CTCRE). Using only the minimum number of the LED1s the power consumption can be minimized but even further by minimizing the number of LED2s. Also the number of at least one type of G2s and D2s can be thus minimized for power saving reasons.

For a Q2 type embodiment of the CTCRE, the branches Tr1 for a transmission LED1 and its corresponding receiver branch Rec1 for the LED2 are demonstrated in the FIG. 1. The branching of the wave guide is demonstrated by the corresponding branches Tr2 and Rec2, that could be arranged to lead to another keying area of an other Q2 key. The number of the branched of the wave guides depends on the key board implementation details, especially how many keys are, if not all, are implemented according to the particular Q2-type related embodiments.

As mere sending and receiving in the DWGE or CTCTE-embodiments do not provide necessarily the key location information on that from what key the pulses were actually coupled to the LED2, if the Tr-branches such as Tr1 and Tr2 for example, and/or the Rec-branches, such as Rec1 and Rec2 for example were not somehow marked to yield the location information about the key pressing. Suitable marking methods can comprise attenuating the signal in the optical signal path in a path specific manner, providing polarization into the signal, to distorting the pulse shape from that as transmitted to that as received. For combining these marking methods together for instance with 5 attenuation levels, 3 polarization characteristics and 4 distorted pulse characteristics yields about 60 different levels. Naturally the detector component, the LED2 should be selected accordingly for this kind of ensemble of embodiments to support the provisions to distinguish the differences between the levels. Pulse shape distortion related embodiments may need for some cases means in the generator and/or detector circuit to facilitate rough pulse shape analysis, which may increase the expenses, but also complexity of the circuit topology.

Thus, the keying area of each Q2-type key can be provided with an indicator, for instance a capacitive indicator, for providing the information of the key position. The capacitive indicator may be suitable as it is cheap, light weight, does not need coils as certain magnetic embodiments could need, but is easy to include into the in-cast structure or as in a layered structure on a layer surface. The indicator is not drawn into the keying area of the Q2. The key position on the key board may be used as such to indicate by the capacitive coupling the key symbol, however, the redundancy can be used to eliminate error signals potentially coupling electro-magnetically to the keyboard's circuitry. In the salted water this may be not a problem, but in other medium as in air or vacuum, in which the key board comprising the key arrangement according to an embodiment may be used in special conditions, as in polluted environment.

According to an embodiment there can be several indications available to a key, the pulsed bit pattern as sent, the location information for the optical signal in a wave guide part, but also the reading of the signal, to be used alone or in suitable combination according to the embodiments.

In FIG. 1 G1, G2 and G3 are demonstrating generating means as used for providing the power and suitable wave form for the lighting of LED1, in embodiments in which the electricity is provided in DC-mode, pulsed mode, or pulsed-biased mode. Biasing can be used to shorten the rising time of the pulses, for reflective keying member embodiments but decrease the dropping time in the dark keying member embodiments (FIG. 5). The D1, D2 and D3 each are demonstrating detection electronics to be used to read the LED2's signals in the corresponding key type Q1, Q2, Q3 embodiment.

Further details on the detailed structure are not shown for D1, D2 or D3 as a skilled man in the art can implement the mere detection and/or pulse counting in several ways as such, but for the embodiments when read and understood examples on the indicated embodiments. Neither are shown further details on the detailed structure for G1, G2 or G3 as a skilled man in the art can implement the mere pulse generation with pulse length and/or the pitch there between two successive pulses in several ways as such, but for the embodiments when read and understood examples on the indicated embodiments.

In an ensemble of embodiments at least one of the layers L1 and L2 can comprise optical filtration applicable material so that the sky-shine can be, if not totally eliminated, at least attenuated, for improving the detection dynamics of the pulses. The material can be used in suitable part, in such a way in such a geometry as patterns for instance that some light can reach the keying member F and further the D2. In some embodiments using capacitive indicator can be arranged into the L2 in one embodiment, in another into a layer above it, and in a further embodiment beneath of the L2. L1 can comprise a protective layer that is made for example as a wear-resistant lack layer. L1 and L2 both or just one can comprise key specific indication of the key for the symbol, letter, number or other character at the keying area location. According to an embodiment between the key specific locations the L1 and/or L2 are not as transparent as at the keying areas, so reducing the sky shine related signal level in the LED2s.

The Q1, Q2 and Q3 are just shown as examples on different embodiments of the invention in a non-restrictive manner. At the Q1 and Q2 the keying member F is demonstrated to touch the L1 layer to facilitate the LED1 originating radiation to be at least partly guided towards the LED2. However, the touching is not necessarily a must for the operation in certain conditions, as demonstrated in the embodiment of the Q3 by drawing the F apart from the L1. Similar way in similar conditions this applies to also Q1 and/or Q2, although the touch is drawn to be demonstrated in the FIG. 1.

The generating means are drawn differently for the keys Q1, Q2 and Q3, just to illustrate that there are many ways to embody the G1, G2 and G3 location in respect to the D1, D2 and D3, not only for physical locating but also in electrical sense, indicating various degrees of mutual integration. The arrows are illustrating the direction of the electromagnetic radiation, as can be embodied for the LED1s and LED2s as visible light, UV-light and/or infrared-light. Different wave lengths can be used, for instance, to create sift-key operations for another key than an ordinary character, so that a capital Q can be created by simultaneous two wavelength bit patterns to be detected.

According to an embodiment of the invention the LED1 can be an ordinary LED normally coupled to send light constantly or in pulses, depending on the corresponding G1, G2, G3, or is there a separate other switch to make the pulsing. According to an embodiment the LED2 is similar ordinary LED as the LED1, but coupled in reverse direction as it were coupled as in LED1. In such mode the LED operates as light detector. An advantage of using ordinary LEDs as LED1s and LED2s is that they are cheaper than specific detector components, similar each other but also robust and simple to handle for operation at a narrow band width as the ordinary LEDs operate. According to an embodiment, also other detectors can be used as LED2s. Especially in the implementations explained in relation to the Q2 key a different detectors can be used for the key board KB.

According to an embodiment of the invention, instead of LED as LED2 phototransistors can be used in suitable part. For rapid pulse rising times photo FETs can be used, especially for integrating the receiver LED2 to the detector circuit D1, D2, D3 and/or tighter to the analyzing electronics. Also photo voltaic cells as detector can be used in an optional embodiment of the invention, especially if the number of receiver LED2s is low, i.e. the cost were smaller than by using other economic LED2s.

Mere pulse counting according to the known techniques is not described as a skilled man in the art knows from the description of the embodiments how to count and/or detect the touches of a key. Similar reasons bit patterns recognition as such is not described in any further detail. Known electronics for controlling the key board as such can be thus applied in the in cast structure according to an embodiment of the invention in suitable part.

According to an embodiment, the KB can be made from plastics by casting for example to form gas tight structure to be operable as key board. In such a way, the manufacturing gives a certain freedom to use the key arrangement comprising keyboard KB in various scuba-diving environments or in the underwater activities to write text as with a normal computer key board. According to an embodiment the KB is arranged to be a part of a communication device, a communicator, integrated into the same cast for providing the same gas-tightness for the communicator and thus to prevent the contact of the medium to the inner parts of the communicator.

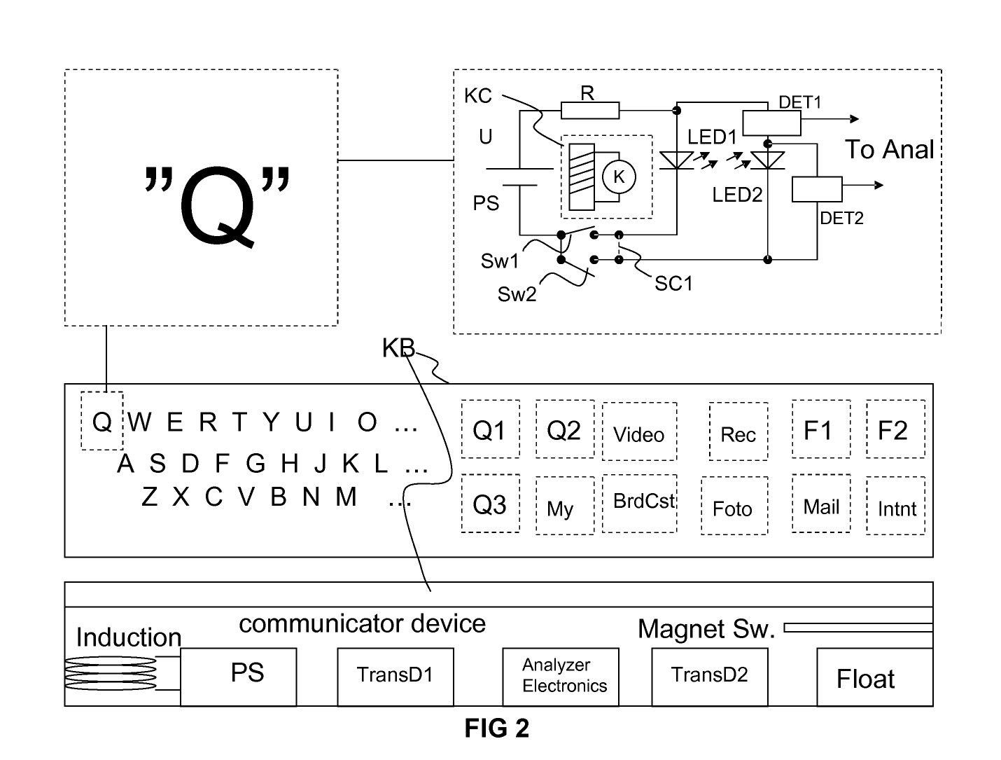

In FIG. 2 it is demonstrated a key board according to an embodiment of the invention. In the example at the middle part of the FIG. 2, the character set is indicated for demonstration of the western “qwerty . . . ” key board. Special control keys, which can be implemented in same way as the indicated normal Q-key, are indicated also in the key board as such as the Q1, Q2 and Q3 for instance for user definable keys. The key “My” illustrates embodiment for “MyKeys” as programmable keys for the user's own use or macros according to the wishes to program with the device comprising the KB. The keys F1 and F2 can be different functional keys than the Q-keys. The F1 and F2 are just separately named for distinction to help the user to remember their functions that as they were programmed. Although a western character system related key board is shown as an example of the KB, the character set to be embodied can be actually made according to any language that can be typed by a key board. The language can be different for different character sets, especially if the character set comprises Cyrillic, Arabic, Chinese, Japanese, Korean or other characters in the set that differs from the western characters. In the key board, also coded keys can be used. Even key boards for virtual languages and/or to the needs of role-players can be manufactured. So, the key names can be given language specifically in the manufacturing phase, into the certain layer or layers onto the plastics in-cast part.

According to an embodiment of the invention the characters are given as in an adhesive foil, to be mounted for example on the KB-plastic part, on L1 or and/or on L2. According to an embodiment the characters are carved. Language specific special characters can be labeled to different layers in an embodiment. This is advantageous; if only one or other limited number of language specific key boards are manufactured. So, for instance, English and French do not necessarily need a different whole KB to be manufactured as the labeling the keys as well as the programming of the meanings were sufficient.

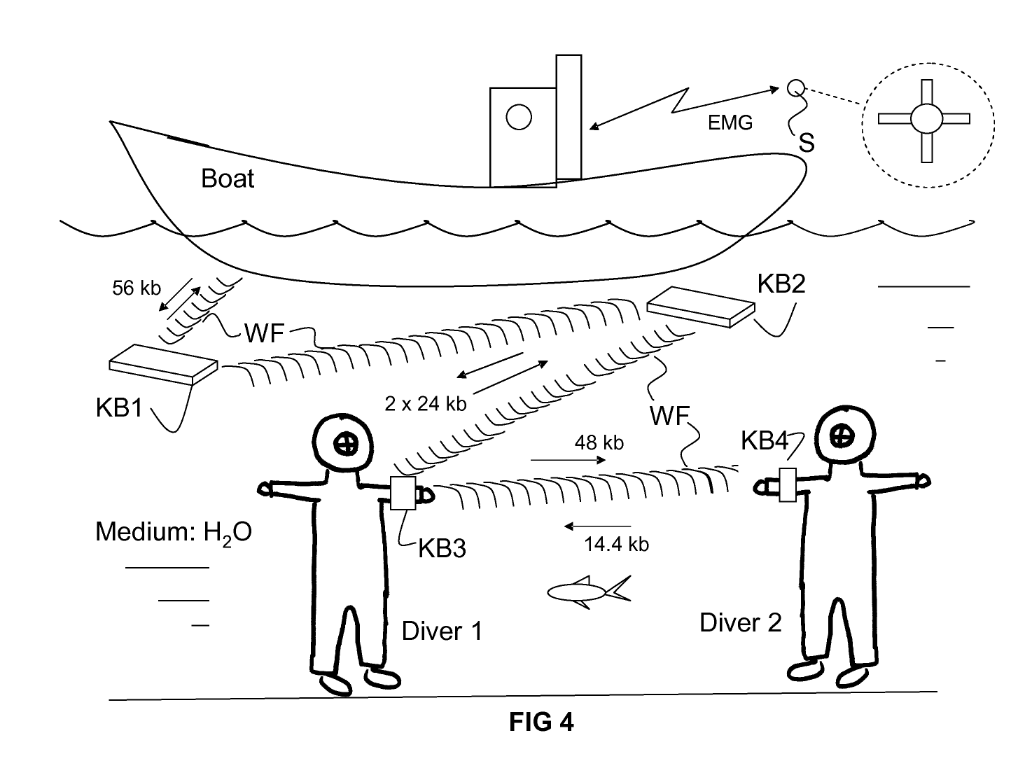

In provision of that the keyboard were connected to a communication device or integrated directly to such a one according to corresponding embodiments of the invention, the keys “Mail” and “Intnt” respectively refer to e-mail and to Internet, to be accessed as further discussed in the FIG. 4. The Foto key refers to a facility to control camera for taking still pictures, Video-key to facility to watch, record, or send video. Brdcst-key refers to facility to broadcast, to send, the signal from the communications device in suitable form to translate into the medium. Rec-key refers to recording facility to control recordings of audio, video and/or still photographs, taken or received from an external message. In an embodiment, the keyboard can be provided with buttons for scuba-diving information functionalities, but also for sensors for the information determination, for instance for the deepness, pressure and/or temperature to be displayed and/or alarmed to the communicator user and/or to the supplying team, but in an embodiment buttons for the timers and/or several alarms for facilitating to get back to surface in a correct way.

According to an embodiment of the invention the keys may be arranged to produce each its own bit pattern, in a simple embodiment, to be used as DTMF-tones. According to the variant of the embodiment the DTMF-tones are in audible range for a human being, but according to another variant at least partly outside the range. According to an embodiment variant the range of the DTMF-tones is in the ultrasound range. This allows a simple pretty straight forward communication protocol to be used between two communicators; especially if/when the DTMF-tones are amplified for a transducer. According to an embodiment the DTMF-tones are analog signals, distinguishable for each key by different characteristics comprising the pulse shape, pulse width, the pulse number and/or pulse duration. According to an embodiment of the invention the DTMF-tones have a digital form that is arranged to be communicatable for sending/receiving the corresponding bit patterns in an audio signal. According to an embodiment the audio signal is in ultra sound range. In such ensemble of embodiments a memory may be not needed as such, as the characters are displayed on the screen of the receiving device in the written and sent order, but such memory for correction buffer were useful in an embodiment.

At the top of the FIG. 2 in left the Q is used to denote to implementation of one key of the key board according to an embodiment of the invention. For clarity reasons only the Q is demonstrated for the electronics at the top-right, according to an embodiment to illustrate various embodiments to implement the detection, LED1 and/or LED2 energization as well as the control of them. However, all the keys that are shown may be implemented in same way, according to an embodiment of the invention, but is not restricted to comprise only one embodiment in the implementation. The LED1 and LED2 were discussed for various embodiments in relation to the FIG. 1. The R represents the resistance, but also impedance in the feeding line feeding the electricity from the Power Source PS to the LED1 at the power source voltage U. The illustrates Keying Control KC and the keying generator K as well as the switches Sw1 and Sw2 illustrate energization facility of LED1 and/or LED2 but the figure illustrates also for the detector circuits DET1 and or DET2 for different kinds of various embodiments. The keying control can be at least partly made by software means arranged to be executable in a microprocessor.

DET1 illustrates such detector circuit that is coupled in series to the LED2. DET2 illustrates such detector circuit that is coupled in parallel to the LED2. Although the DET1 and DET2 are shown in the figure, the number of the DET1 and DET2 is not necessarily at all dependent on each other's number. The Sw2 demonstrates that the LED2 can be controlled according to a control signal. The Sw1 demonstrates that the LED1 can be controlled according to a control signal. Although only one means KC and K are drawn to demonstrate the keying facility, a skilled man in the art knows, that the Sw1 can be controlled independently or in certain phase there between with separate means, for the functionality embodied in relation to FIG. 1. In addition, the coil-switch symbols are used mere illustrative reasons, as in real embodiments the functionality can be implemented in various ways by using semiconductors, as a skilled man in the art knows from when read and understood the shown embodiments.

The arrows from the DET1 and DET2 indicate the signal direction to the Analyzing electronics that determines according to the signal which key board key was typed. The DET1 and/or DET2 can be embodied in suitable part for the D1 and D2. Transistors and FETs can be used in suitable part for implementation of the LED2 for its integration into the DET1 or DET2 in suitable part. According to an embodiment, the G3 can be integrated to the same circuit as the D3, which can be implemented in suitable part according to the D1 and/or D2.

At the lower part of the FIG. 2 there is indicated a side profile of the KB. The power source PS is in the same in-cast molded structure as the rest of the key board. In this embodiment, the power source PS is rechargeable type and can be recharged inductively by the induction means indicated by the solenoid Induction, arranged into the same in-cast molded structure. The figure does not show the other part of the induction means outside the KB, but a skilled man in the art knows that the inductive recharging can be made in a similar way by using magnetic coupling as in the implementation within the certain known wireless electric tooth-brushes. The Magnet Sw. demonstrates the main switch implementation of the KB so that the main switch is inside the in-cast molded structure, but the operation of main switch is controlled magnetically outside the KB, so once again avoiding any mechanical assembly openings that could compromise the gas-tightness of the KB.

According to the example of the KB in the FIG. 2 there is indicated also an analyzer electronics inside the in-cast structure, that can comprise according to an embodiment key board related modules or electronics in suitable part according to the known techniques. In addition in the example, there is also a transducer TransD1 indicated to demonstrate an electro-mechanic transducer to be used as a transmitter of audio signal. In an embodiment that is addressed also to use outside salty water environment, there can be also an RF-transmitter in addition or instead, depending the embodiment versatility properties to be utilized in different environments. The transducer TransD2 illustrates a receiver that can be used to receive audio-signals and to translate them into an electric form. In an embodiment the signal can be further processed by the Analyzing electronics and the micro processor in the KB. In an embodiment that is addressed also to use outside salty water environment, there can be also an RF-receiver in addition or instead, depending the embodiment versatility properties to be utilized in different environments. The transmitting of the audio signals by the TransD1 and/or TransD2 can be made in a digital way, for modems connectable into the phone line, but as audio pulses in a similar way as was utilized in the as such known phone modems.

According to an embodiment of the invention the functionalities of the TransD1 and TransD2 can be implemented with single transducer that is operated so that the transmission and receiving modes alter, or as in an embodiment the signal is so coded and/or processed, that the transmission and receiving is made simultaneously. One way to do that is to use different frequencies for sending and receiving. According to an embodiment of the invention also duplexing familiar as such from the branch of radio-communication with mobile terminals can be used in suitable part for the embodiments, as with sound pulses in underwater conditions suitable embodiments. According to an embodiment of the invention the TDMA scheme and/or CDMA scheme can be applied to the sending and/or receiving as in the radio-communication for the selection of corresponding sending and/or .receiving frequencies.

The FIG. 2 does not show display means in the in-cast structure. However, various normal display-types can be used in corresponding embodiments. In option or in addition, transducer can be used for speech synthesis for repeating the characters as words that were written with the keyboard into its memory.

The part FLOAT illustrates a section for the KB that is used to arrange the KB to have certain average density and so to optimize the buoyance of the medium. The KB can also have external hooks or other attachment means to attach further weights or enlightening parts on the KB to adjust lower, to balance, or to increase the buoyance.

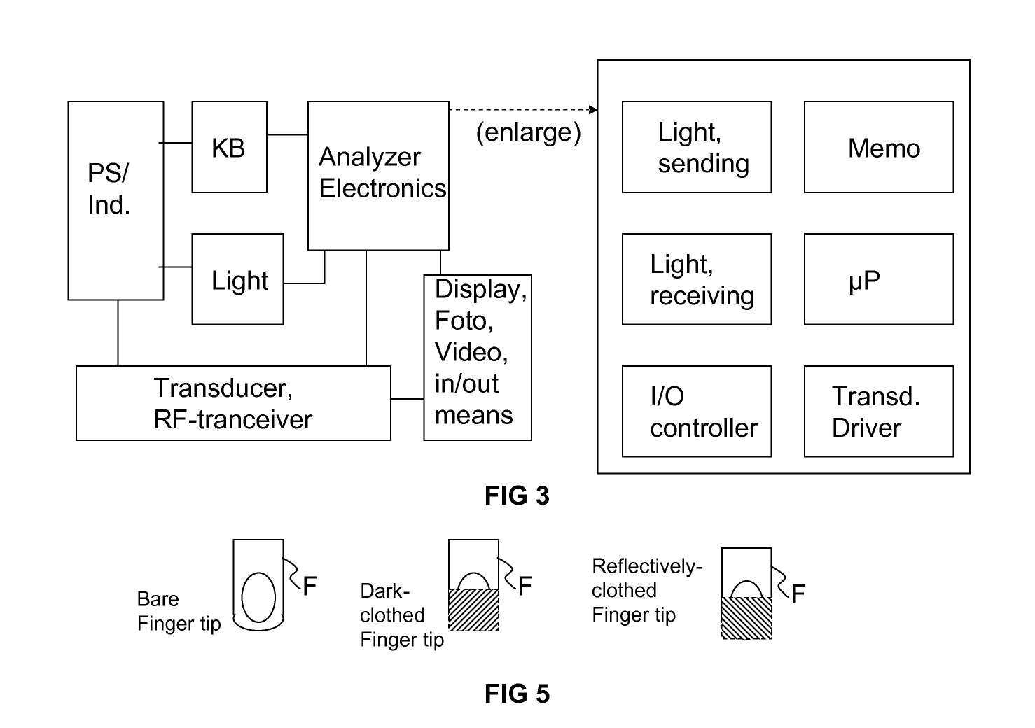

The FIG. 3 illustrates in schematic way an example of an embodiment of the invention as embodied in a communications device. The mere KB refers to mere collection of the keys that form the keyboard, in an accordance of the embodiments previously explained. FIG. 3 also indicate presence of a display, for showing the characters and their combinations to form words, graphics, photographs and/or videos. The figure illustrates in the example that the Analyzer electronics comprises means for controlling I/O operations for external communications, light sending and receiving for the keyboard key operations, means to control transducer via the Transducer driver. The Analyzer electronics is indicated to have a micro processor μP for data operations as well as computing facilities relating to the functionality of the communicator according to an embodiment of the invention. The memory Memo is indicated to comprise the software that is controlling the operation of the key board as well as the external I/O operations, camera operations, transducer operations, the communication protocol details, as well as the operation related parameters and programs, scripts and other routines, including also the power source condition control.

Although the shown topology as an example, other layouts are also possible without leaving the scope of the embodiments.

FIG. 4 illustrates an acoustic communications system that utilizes KB according to an embodiment of the invention as a system element, but also the use of the KB in a communication according to an embodiment of the invention and a related integrated communications device, communicator, for under water communication. Thus the KB1, KB2, KB3 and KB4 each refer to a keyboard KB according to an embodiment of the invention, but also to a communicator comprising such a respective KB. The schematically drawn fish-figure and the H₂O are illustrating an under-water environment, as well as the Boat on the surface. The FIG. 4 illustrates also two divers Diver 1 and Diver 2 that are having communicators according to an embodiment of the invention, attached on their arms, so that they can use the indicated KBs, KB3 and KB4 in the corresponding communicators. The divers have agreed with each other on the frequencies to be used for sending and receiving signals. According to an embodiment of the invention the communication between the KB3 and KB4-related communicators is arranged so that communicating parties use a single frequency. In this kind of embodiments there can be used a conflict management protocol to recognize the senders and listeners, in a similar way as in for example in Ethernet networks, but within an acoustic carrier. According to an embodiment of the invention the KBs or the related communicators can have an additional optical output link for outputting information. According to an embodiment of the invention the KBs or the related communicators can have an additional optical input link for inputting information to the device. According to an embodiment of the invention such input and/or links are sealable by a plug or lid that does not pass radiation in optical wave length range, in infrared, and/or ultraviolet range.

The KB3 is illustrated to send to the KB4 an audio-signal at 48 kb rate in digital form as a pulse sequence coded according to a known way as such. The KB4 is sending back wards to the KB3 another digital signal in audio form at rate 14.4 kb as indicated. The signal comprises a file that was saved in the KB3 memory. The file is intended to be sent in an e-mail to a Diver2's friend, for example. As an attachment of the message, there is a photo shot from the fish there between the divers, and a text part in the e-mail. The message is conveyed via the Diver 1 carrying the communicator with the KB3, to the communicator KB2 that is floating in the sea as well as KB1, the KB2 as well as the KB1 being used as repeaters for the communication between the divers and the Boat, but also for a further connections. The KB1 and/or KB2 may be suspended by a buoy with suitable marks to find and identify them after the underwater actions when leaving and collecting the equipment, although the buoy is not drawn into the FIG. 4. The KB1 and/or the KB2 could be permanently mounted, if the environment were such that there were divers sufficiently often, as in a military training centre, or as in a suitable tourist trap. The KB2 communicates at 24 kb rate in both directions with KB1 and KB3. As there were possibly outside the figure further divers, to communicate with, the KB1 is arranged to communicate at 56 kb with the Boat, for both directions. The message of the Diver 2 proceeds from the Boat in this example in electromagnetic form EMG to a satellite communication system demonstrated by the satellite S. From the satellite, if no land stations available, the message proceeds to communication networks at whose end the targeted receiver can receive and read the message. Of course, the target can also send an acknowledgement message backwards. As audio signals, the sent signal by the KB4 is encrypted so that the repeaters KB1, KB2 and the as-repeater used KB3 cannot directly see, so providing some privacy for the communication. The wave fronts WF are drawn as they were direction sensitive for illustrative clarity reasons only to demonstrate the exemplified connections. In reality such a narrow sound beam may be difficult to be obtained if not entirely impossible. However, normal sound propagation characteristics in the medium according to the medium specific properties is sufficient for the sound to be transferred from one point to another point, i.e. between the divers, in a real environment.

According to an embodiment of the invention the sound is sent and received as audio pulses. According to an embodiment with digital pulses, in one embodiment ensemble the frequency can be at least partly in the human audible range. According to another embodiment the audio pulses comprise frequencies above the human audible range.

However, the upper limit to the pulse frequency is medium specific. In the conditions with water as medium the maximum distance for communication with signals below 100 kHz digital pulses is determined by the attenuation of the sound in the water, but also from the transmitting power as well as the receiver sensitivity but also the signal processing made in communicator for detecting the signal. Thus, although approximately 50 kHz pulses can be used for communication for long distances below 500 m for example, higher frequencies below 1 MHz can be used at least in shorter distances, the exact maximum distance depending on the attenuation of the sound at the frequency used for an arbitrary set up of receiver and transmitter. Thus, the indicated values for frequency are only examples on embodiments that are not limiting the frequency range. Thus, according to an embodiment of the invention the transducer can be adjustable for the sending frequency, or several attenuators can be used for several frequencies.

According to an embodiment of the invention various KB-device comprising communicators can be arranged to communicate according to the similar way as transmitters and/or receivers in a time division multiple access (TDMA) system addressed to the radio communication. The addressing for the device identification as well as error rate handling can be implemented according to the TDMA standards in suitable part. Alternatively or in addition to, according to an embodiment of the invention the communicator according to an embodiment can be arranged to communicate according to the similar way as transmitters and/or receivers in a code division multiple access (CDMA) system, addressed to the radio communication. The addressing for the device identification as well as error rate handling can be implemented according to the CDMA standards in suitable part. Protocol, to reserve resources to a communicator acting as a network element in a network, that is familiar from various known implementations of CSMA techniques (CSMA/CD for instance) can be applied in an ensemble of embodiments to resolve potential collision situations between coming and going information items at such a communicator.

According to an embodiment of the invention the communicators according to an embodiment of the invention can be arranged to operate as elements of a network of such communicators. According to an embodiment of the invention suitable access protocol can be used for the appropriate addressing of the communicators in such a network. According to an embodiment of the invention, suitable features for encoding/decoding and/or encryption according to a known network protocol can be used in suitable part.

As the pulse frequency for a digital sound pulse propagation may be limited by the medium properties derivable from the phases and/or the composition of the medium in detail, at least in some extent, according to an embodiment of the invention, any other known and/or standard access method can be embodied in suitable part for the communication of the communicators in the medium.

In FIG. 5 the keying member F related embodiments are demonstrated. According to an embodiment of the invention the keying member can be a stick that directs at least part of the light from LED1 to LED2. According to an embodiment demonstrated in FIG. 5 the keying member can be a finger tip as the illustrative way of drawing in the FIG. 1 and also in FIG. 5 demonstrates. According to an embodiment of the invention the finger tip F may be bare finger tip, but in another embodiment the finger tip can be covered by cloth that comprises either dark or reflective material arranged to meet the light in its path from LED1 to LED2. According to an embodiment the reflective material is on a glove at its finger tips. By using the dark keying member part at the end of it, it is possible to use reverse logic to interpret the key signals as the dark matter drops the sent signal level from LED1 to lower level seen by the LED2, and the pulses are interpreted in the analyzer electronics as a key according to the pulse characteristics and/or the location information, for example for a key “Q” that is used in the examples. In the non-reverse, positive keying pattern, by using reflective or light material at the keying member-tip, the pulses from the touched key have level that is adjusted to be higher than the background and are thus counted as pulses and recognized to the keys according to the corresponding pulse characteristics of the pulses in the ensemble of pulses.

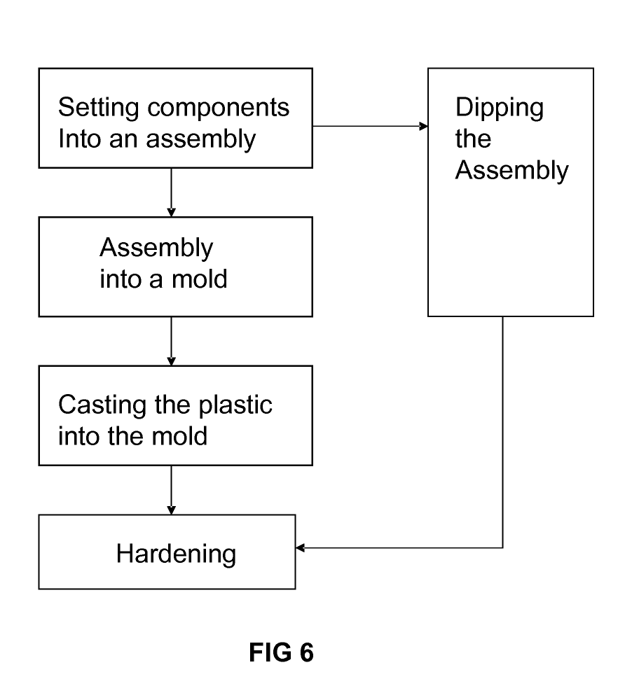

FIG. 6 demonstrates a manufacturing method of a key arrangement according to an embodiment of the invention. In the method, the components of the arrangement are put together to comprise the functional wholeness of the key arrangement to form a keyboard and/or the communicator in an assembly. Then the assembly is put into the mold, and plastics are cast into the mold, so that the key arrangement is captured into the plastics as an in-cast structure. The cast is allowed to harden. Optionally the assembly can be dipped as the candles are made into the plastics forming chemicals so increasing the size layer by layer. According to an embodiment of the invention, the in-cast structure is purified, and/or polished in suitable part. According to an embodiment, the structure is finally lacquered or covered with water and wear resistant material.

According to an alternative embodiment of the invention the mold for an assembly of key arrangements comprising at least one single key of the key arrangement, or the mold for an entire keyboard is made so that it finally forms a part of the in-cast structure. Thus, for instance, the mold can be made by cutting, bending, pre-casting and/or machining so to make the space for the parts of the key arrangement according to the embodiment in question, in a preparation phase, before the embodiment specific parts as well as peripherals to them are cast into the in-cast structure by plastics.

Although LED as Light Emitting Diode is mentioned as a receiver and/or a detector part, in an ensemble of alternative embodiments at least one of the receiving LEDs may be replaced by another light receiver as further embodied in the embodiments. In an ensemble of alternative embodiments at least one of the transmitting LEDs may be replaced by another light transmitter as further embodied in the embodiments, although the power consumption in such embodiment may be higher than that of a single LED used for a light source. In an ensemble of variants of the embodiments, at least one receiving LED and at least one transmitting LED are replaced by another component for the same respective purpose.

However, the writer of this document is not aware of any applications in which a pair of LEDs were used according to the embodiments of the invention for making an optical switch to be used as a mechanical switch or a keyboard key, but as sealed into an in-cast structure in certain geometry within a wave guide that allows switching light, from an LED arranged to operate as light source, to an LED arranged to operate as light detector, in a controllable manner by a keying member as in the currently embodied in this document.

According to an embodiment of the invention the ultra-sound broadcast is coded in one embodiment and encrypted in another and both used in a further. In one ensemble of embodiment the ultra-sound broad cast content is randomized, so that the receiver can filter off sounds originating to mammals or other organisms living in under-water environment.

Although the message structure as such is not described in detail explicitly in the examples, the collision detection and the related identification protocol can cause need for certain over-head structure for the messages and/or related data packages, which are however programmable in suitable part for the communicators in the embodiment in question. Thus, for example the sender and receiver can communicate in the same acoustic frequency provided that the communicating devices are configured to obey a collision detection protocol, which can be a known protocol as such. In one ensemble of embodiments i2c-protocol is used for the package conflict management.

It is apparent to a person skilled in the art that as technology advanced, the basic idea of the invention can be implemented in various ways. The invention and its embodiments are therefore not restricted to the above examples, but they may vary within the scope of the claims.

### Example 1

An ensemble of embodiments of the invention is illustrated in the FIG. 7. In the example, there is shown a generator G to generate signal for the LED1s, (which is/are not shown in FIG. 7 for simplicity). By using the G as generator it is used to demonstrate embodiments that use one generator common to all keys or just a group of keys, but also such embodiments in which there is at least one single generator for each key in the group which thus comprises several generators for the group. The generator G is arranged to point each key in the group by polling the keys in series, each key in a time interval so that the keying are at the key receives lighted that corresponds the key symbol. Each key is recognizable by the characteristic bit pattern that is specific for the key, the bit pattern carried by the light. Without any intention to limit only to any particular western letter-system keyboard, the FIG. 7 illustrates keys Q, W, E, R, T, Y to be polled by the G in series in an order during the respective time intervals Δt1, Δt2, Δt3, Δt4, Δt5, Δt6 etc. . . . . In the FIG. 7, the time intervals are separated by a separation marker, so that the detection electronics denoted by symbol Det can discriminate the keystrokes as separate keys better than if there were no separation at all. Separation marker can be embodied in several ways, which are not described as such.

In the example, the G is demonstrated to be synchronized to the Det so that the Det knows what keys are to be expected to couple via the wave guides to the LED2s, when the F couples the light coming from a LED1 to arrive to a corresponding LED2 to be detected as a key symbol. In the example of FIG. 7 the letters Q, W and E have been indicated respectively to correspond bit patterns “110110”, “110111” and “111000”, without any intention to limit embodiments only to the shown example.

At the receiving side, the Det is shown to discriminate the states Yes “Qs” present and no “Qs” present from each other as based on a threshold to represent positive logic to have Qs or not. In negative logic the indication of “Qs” present and not are switched for that embodiment. There is no scale as such drawn for the discrimination, nor the duration of the keys exemplified by the “Qs”, but the level recognition is recognizable as such for a skilled person in the art from the embodiments. From the synchronization from the G the Det knows what characters are to be expected to be included into the message to be written.

In a simple embodiment, the G sends the bit pattern for example for Q, but also via the line synchronize to the Detector electronics Det that is arranged to do an and-operation with a provision that the signal level from the corresponding LED2 or the related branch differentiate from the threshold value of the signal level in a preset manner. In the embodiment the Det waits during the Δt1 the Q to be coupled by the member F for the and-operation, until the next character is to be waited to be appear at the Δt2 moment. When a character is present, the Det is arranged to latch the character further to the other parts to be include into the message and/or to be shown on the display. Also, in an embodiment a corresponding DTMF-tone can be sent via the transducer into the medium. The elongated rectangular shaped objects between the Det at right from the demonstrated keys illustrate wave guides for leading light from keys to LED2s that are indicated at the receiving side by LEDs and the LED2s. The symbolic way of drawing is used only for simplicity, but a skilled man understand from the embodiments that the bar demonstrates common wave guide as well as key specific wave guides. Equally well, skilled man understand from the embodiments that the other bar demonstrates common LED2 as well as key specific LED2s.

### Example 2

In this example, an ensemble of shielded embodiments are demonstrated. The communicator or a mere keyboard is arranged so that the cast structure comprises a conductive film around the electronics in the keyboard comprising piece. According to an embodiment of the invention, there is only one shield layer around the electronics, an all device shield, for such a structure that is embodied in FIG. 2 for instance, except the parts that are related to the power source loading by induction. If the shield layer were such a layer that would not influence on the magnetic flux to the induction recharging, the structure were simpler to make, as the induction coil could be included into the interior parts of the shielded communicator/keyboard. If not included, also magnetically shielding materials can be used for making Faraday's cage for the electronics. According to an embodiment of the invention the cast structure is arranged to form Faraday's cage around the electronics of the device. According to an embodiment of the invention even the parts can be each individually shielded. Thus, the number of the Faraday's gages is not limited to the mere shown number corresponding to the parts. Thus, there can be even nested Faraday's cages. According to an embodiment at least one of the cages is arranged to be grounded. According to an embodiment of the invention a cloth of the user is used in the grounding.

According to an embodiment each module or part of the electronics is individually shielded. According to an embodiment the shielding comprises additionally also an all device shield in addition to the shielded modules.

According to an embodiment of the invention the film is made by using conductive grains in the cast material for the layer. Accordingly, the device can be dipped into a mold for the shield layer making in an embodiment, but in another the layer is sprayed on the device. In a further embodiment the layer may be made by ablation, or another coating method. In the shield making the key parts should be covered for allowing the use of the F for the light coupling, or optionally the coupling areas carved or worked for passing the light out of the key.

According to an embodiment of the invention, the communicator/mere keyboard can be provided with an optical link for outputting the keyboard entries and/or received messages at least partly outside of the shield in signal of optical form. According to an embodiment of the invention, the communicator/mere keyboard can be provided with an optical link for inputting information for the use in the device.

According to an embodiment of the invention the FIG. 7 illustrate a facility to alter the keyboard operation as in the synchronize-line from the G to Det there is there between indicated a box “To encrypt” that symbolizes encryption by encryption means. According to an embodiment the pressed keys can be read as other keys according to a predetermined coding table. Thus, the encryption means indicated in FIG. 7 thus facilitate scrambling of the text. According to an embodiment of the invention, the encryption can be made via a buffer, so that the writer see at least partly the written text correctly as typed in the display in the writer's use, but the outgoing text is scrambled according to the coding table used in the encryption. The functionality can be used in the acoustic communication when the embodiment is arranged so, but also in such embodiments that comprise the optical link for outputting. The Coding tables to be used in the encryption can be changed by the software controlling the functionality of the device. So there can be several coding tables available to encrypt the written text. This is demonstrated by the coding 1 and coding 2, without any limitation to the number of coding tables. According to an embodiment the coding tables can be updated. According to an embodiment also messages comprising other information can be encrypted. According to an embodiment the coding table can be sent to a remote communicator as encapsulated message so that other remote communicators can not see the coding table straight without appropriate password or other symbol to get access to the code table.

Such embodiments can be used for instance in various military applications or in other applications in civil or near civil technology branches that deal with classified messages.

Although the encryption is embodied as in relation to example in FIG. 7 related embodiments, skilled men in art know from the shown examples that the encryption can be implemented in various ways in various shown and indicated embodiments that in many ways.

Although the encryption means are drawn to be in the line between G and Det, according to an embodiment of the invention even the G can be controlled to send keys already in encrypted order, provided that the control of the coding according to the coding table is utilized for driving the G, as according to one embodiment ensemble, without encryption in the synchronize line.

### Example 3

A communicator, according to an embodiment of the invention, comprising a KB, comprises electromagnetic means arranged to send information in an electromagnetic form by a suitable carrier. In such an embodiment, implemented by radio waves, the communicator can be used in conditions where no or essentially no sound can propagate, provided, that at least one of the transducers in the communicator is either replaced by a known radio transceiver and the electronics adapted for such communication or there is a parallel transceiver for the no-sound condition to the transducer. In such an embodiment, also the shielding and/or encrypting by the keyboard can be used according to an embodiment internally in the device, in addition to the communication protocol over the radio link-interface, which can be as such a known protocol in an ensemble of embodiments.

### Example 4

According to an embodiment the electronics of the communicator can comprise electronics for an acoustic modem for wired communications known as such. In such an embodiment various known as such techniques for error correction, compression, coding and/or packing of the information can be used in suitable part from the known modem techniques. However, according to an embodiment of the invention a transducer of the communicator is arranged to be controlled for producing the acoustic signal to pass the bit stream from the modem into the medium. Thus it is not necessary to provide metal wires for the communication line from a device to another. At the receiving end another transducer can receive the acoustic signal comprising the information in the bit stream and transform it to an electric signal to be processed in the receiving device. Embodiments in various examples are combinable in suitable part.

According to an embodiment of the invention the device is arrange to detect and recognize/categorize under water sounds. Such embodiment is useful in conditions where sonar for instance is used, and/or animals are present that produce sound in ultra sound frequencies at the same frequency range as a communicator. So, when presence of sonar, for instance, is detected, the communicator can communicate with the appropriate other devices and agree another frequency onto which to hop, until the disturbance is over, or to remain in the same frequency.

1-19. (canceled)

20. An electro-optical key arrangement, comprising:
at least one key, the at least one key including:
a transmitter arranged to transmit photons within a wavelength range that includes at least one wavelength into an optical path;
a receiver arranged to receive photons at least partly from the optical path, and to convert received photons into an electrical signal; and
a detector circuit arranged to detect a change in the electrical signal and to generate a respective key-specific electrical signal;
wherein the transmitter and receiver are arranged in a common in-cast molded structure body that includes the optical path arranged such that touching a part of the optical path between the transmitter and the receiver causes the detector circuit to generate the key-specific electrical signal.

21. The arrangement of claim 20, wherein at least one of the transmitter and receiver is a light-emitting diode.

22. The arrangement of claim 20, further comprising in the optical path a solid waveguide for guiding photons between the transmitter and receiver.

23. The arrangement of claim 20, wherein the detector circuit comprises the receiver.

24. The arrangement of claim 20, comprising a plurality of keys, wherein each key of the plurality of keys includes at least one of the receiver, the transmitter, and the detector circuit.

25. The arrangement of claim 24, wherein each of at least a first key and a second key of the plurality of keys includes different ones of the receiver, the transmitter, and the detector circuit.

26. The arrangement of claim 20, comprising a plurality of keys, wherein transmission by a transmitter of a key is key-specifically coded by a coder, whereby the key is distinguished from another key in a time-division space-coding of the plurality of keys.

27. The arrangement of claim 26, wherein at least a first key and a second key comprise respectively a first optical path and a second optical path from a common transmitter.

28. The arrangement of claim 26, wherein at least a first key and a second key comprise respectively a first optical path and a second optical path to a common receiver.

29. The arrangement of claim 20, comprising a plurality of keys, wherein the plurality of keys are configured as a key board.

30. The arrangement of claim 29, wherein the key board is included in a communication device.

31. The arrangement of claim 30, further comprising a transducer arranged to operate as at least one of a transmitter and a receiver to respectively transmit and to receive acoustic pulses as digital signals.

32. The arrangement of claim 31, further comprising a repeater arranged to repeat a received acoustic signal.

33. The arrangement of claim 31, further comprising at least one of means for transmitting and/or receiving an acoustic signal in a medium in a time division multiple access (TDMA) scheme, and means for transmitting and/or receiving an acoustic signal in a medium in a code division multiple access (CDMA) scheme.

34. The arrangement of claim 31, further comprising means for communicating in a carrier sense multiple access with collision detection (CSMA/CD) scheme in a communication network.

35. The arrangement of claim 31, further comprising an acoustic modem adapted to operate on an acoustic carrier in medium.

36. The arrangement of claim 35, further comprising at least one of means for error correction, means for encryption, means for package collision handling, and means for providing a message with an overhead of an information transfer protocol.

37. The arrangement of claim 35, wherein the medium comprises at least one of water, air, another gas, a partial vacuum, and a multi-phase medium.
